(19) United States
(12) Patent Application Publication
(10) Pub. No.: US 2019/0248254 A1
(43) Pub. Date: Aug. 15, 2019

(54) VEHICLE SEAT SYSTEM

(71) Applicant: TOYOTA BOSHOKU KABUSHIKI KAISHA, Aichi (JP)

(72) Inventors: Haruki UNO, Aichi (JP); Kazuhisa NIIMI, Aichi (JP)

(73) Assignee: TOYOTA BOSHOKU KABUSHIKI KAISHA, Aichi (JP)

(21) Appl. No.: 16/253,723

(22) Filed: Jan. 22, 2019

(30) Foreign Application Priority Data
Feb. 14, 2018 (JP) 2018-024343

(51) Int. Cl. B60N 2/02; B60N 2/12; B60N 2/20; B60N 2/01

(52) U.S. Cl. CPC B60N 2/0244; B60N 2/12; B60N 2002/0256; B60N 2/01; B60N 2/20

(57) ABSTRACT

Disclosed is one example of a vehicle seat system that is capable of shortening a time duration required until a third-row seat becomes available for boarding or deboarding. During execution of boarding or deboarding mode-conversion process, executed are front seat-pivot in which a first seatback is displaced seat-frontward in a pivoting manner; a first operation in which at least one of a second seat cushion or a second seatback is displaced relative to the other of the second seat cushion or the second seatback so that the second seat cushion faces the second seatback; and a second operation in which the second seat is displaced seat-frontward. During the execution of the boarding or deboarding mode-conversion process, the second operation is executed in response to the first seatback being placed in a specified state subsequent to execution of the front seat-pivot.

### CROSS-REFERENCE TO RELATED APPLICATIONS

This application claims the benefit of Japanese Patent Application No. 2018-24343 filed on Feb. 14, 2018 with the Japan Patent Office, the entire disclosure of which is incorporated herein by reference.

### BACKGROUND

The present disclosure relates to a vehicle seat system comprising vehicle seats.

In the invention disclosed in U.S. Patent No. 20170282754, for example, a vehicle front seat retreats to be placed in a withdrawn state and thereafter a vehicle rear seat is operated. The withdrawn state is where a vehicle front seat and a vehicle rear seat cannot interfere with each other even when the vehicle rear seat is displaced.

### SUMMARY

For example, a vehicle may also include, in seat-rearward of a vehicle rear seat (hereinafter, referred to as a second-row seat), a vehicle seat (hereinafter, referred to as a third-row seat). In this case, when a boarding/deboarding passenger boards or deboards the third-row seat, it is necessary to execute a boarding or deboarding mode-conversion process in which the second-row seat is displaced seat-frontward (frontward) to increase a distance between the second row-seat and the third-row seat.

Therefore, even if the aforementioned boarding or deboarding mode-conversion process is executed in the invention disclosed in the aforementioned publication, the third-row seat cannot be available for boarding or deboarding until the vehicle rear seat (second-row seat) completes its frontward displacement subsequent to the vehicle front seat completing its retreatment.

In other words, the invention disclosed in the aforementioned publication requires a time duration until the third-row seat becomes boardable or deboardable. In view of this point, in the present disclosure, it is desirable to provide a vehicle seat system that can shorten the time duration required until the third-row seat becomes boardable or deboardable.

An “occupant” according to the present disclosure refers to a crew of a vehicle and a person who uses the vehicle. Accordingly, the occupant includes a person who is not seated in reality.

A vehicle seat system of the present disclosure comprises a first seat mounted onto a vehicle, the first seat including a first seat cushion and a first seatback; a second seat mounted seat-rearward (rearward) of the first seat within the vehicle and including a second seat cushion and a second seatback; a third seat mounted rearward of the second seat within the vehicle; and a control device for controlling respective displacement of the first seat cushion, the first seatback, the second seat cushion, and the second seatback, the control device being able to execute a boarding or deboarding mode-conversion process in which a distance between the second seat and the third seat is increased.

During execution of the boarding or deboarding mode-conversion process, executed are front seat-pivot in which the first seatback is displaced frontward in a pivoting manner; a first operation in which at least one of the second seat cushion or the second seatback is displaced relative to the other of the second seat cushion or the second seatback so that the second seat cushion faces the second seatback; and a second operation in which the second seat is displaced frontward.

During the execution of the boarding or deboarding mode-conversion process, the control device executes the second operation in response to the first seatback being placed in a specified state subsequent to execution of the front seat-pivot.

This shortens a time duration until the third seat becomes boardable or deboardable (hereinafter, referred to as a boarding or deboarding enabling time), in comparison with a vehicle seat system in which a vehicle rear seat (second-row seat) is operated subsequent to retreat of a vehicle front seat bring completed.

There may occur a contacting state in which, in response to execution of the second operation, the first seat and the second seat come in contact with each other. This further shortens the boarding or deboarding enabling time.

The control device may cause the second seatback to be tilted frontward in the first operation, and may cause, subsequent to a start of the first operation, the second seat cushion to pivot about a seat-front end side of the second seat cushion as a pivot center in the second operation such that a seat-rear end of the second seat cushion is displaced frontward. This shortens the boarding or deboarding enabling time, for example, in a vehicle seat system for a vehicle that enables a tumble operation.

In the contacting state, the first seatback and the second seatback may come in contact with each other. This further shortens the boarding or deboarding enabling time, for example, in the vehicle seat system for the vehicle that enables the tumble operation.

The control device may cause the first seat cushion to be displaced frontward in a sliding manner during the front seat-pivot. This more securely shortens the boarding or deboarding enabling time.

### BRIEF DESCRIPTION OF THE DRAWINGS

An example embodiment of the present disclosure will be described hereinafter with reference to the accompanying drawings in which:

FIG. 1 is a view showing a configuration of a vehicle seat system according to a first embodiment;

FIG. 2 is a block diagram of a control system of the vehicle seat system according to the first embodiment;

FIG. 3 is a view showing an operation scheme of the vehicle seat system according to the first embodiment;

FIG. 4 is a flowchart showing an operation control of the vehicle seat system according to the first embodiment;

FIG. 5 is a time-chart showing the operation control of the vehicle seat system according to the first embodiment;

FIG. 6 is a time-chart showing the operation control of the vehicle seat system according to the first embodiment; and

FIG. 7 is a view showing a configuration of a vehicle seat system according to a second embodiment.

### DETAILED DESCRIPTION OF THE PREFERRED EMBODIMENTS

An “embodiments” to be described below is one example of embodiments that belong to the technical scope of the present disclosure. In other words, invention-specifying matters recited in claims are not limited to specific configurations, structures, and the like that are shown in the embodiments below.

At least in respect of a member or portion that is labeled with a reference numeral for explanations, there is at least one in number of such a member or portion unless the number is otherwise specified, for example, as “one of.” In other words, there may be two or more of such a member or portion when the number is not specified.

The present embodiment is a seat (hereinafter, referred to as a vehicle seat) that is mounted onto a vehicle such as an automobile and the like. Arrows and other marks that indicate directions labelled on each drawing are made for easy understanding of relationships between each drawing.

The present disclosure is not limited to the directions labelled on each drawing. The directions shown in the drawings are based on a state where the vehicle seat according to the present embodiment is assembled to the vehicle.

### First Embodiment

1. Overview of Vehicle Seat System

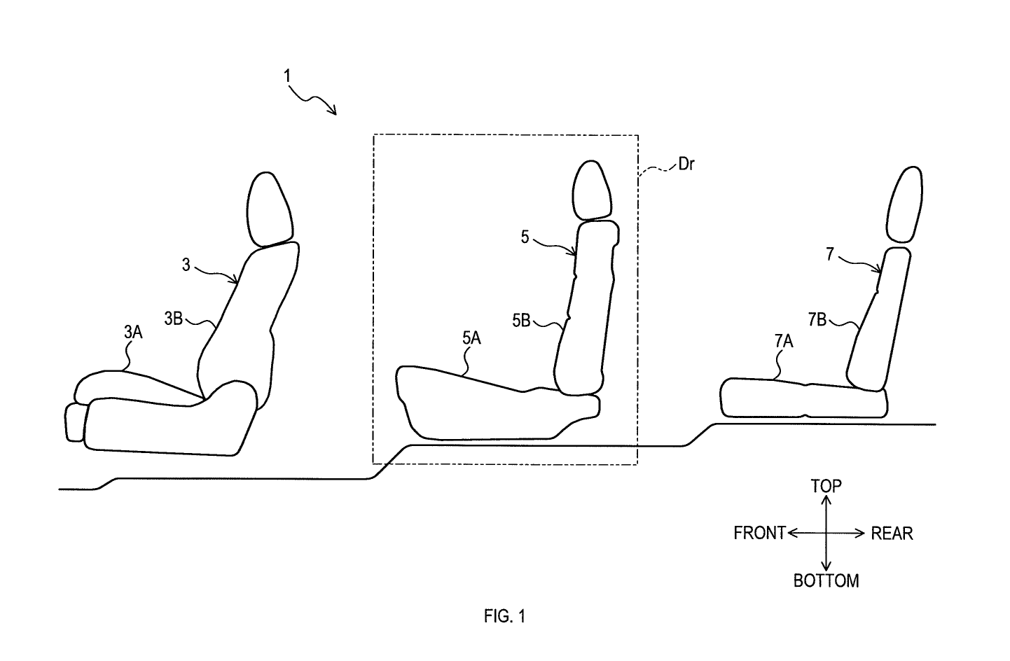

As shown in FIG. 1, the present embodiment is application of a vehicle seat system 1 to a vehicle seat mounted onto a vehicle. The vehicle seat system 1 comprises at least a first seat (hereinafter, referred to as a front seat) 3, a second seat (hereinafter, referred to as a first rear seat) 5, a third seat (hereinafter, referred to as a second rear seat) 7, and the like.

The first rear seat 5 is mounted seat-rearward (rearward) of the front seat 3 within a vehicle cabin. In the present embodiment, a seat front-rear direction (front-rear direction) corresponds to a vehicle front-rear direction. In other words, the first rear seat 5 is mounted closer to a vehicle-rear side than the front seat 3 is. The second rear seat 7 is mounted closer to the vehicle rear side than the first rear seat 5 is.

Here, the front seat 3, the first rear seat 5, and the second rear seat 7 are vehicle seats mounted on a passenger-seat side of the vehicle (leftward, in the present embodiment). A vehicle door Dr for boarding or deboarding is arranged on one side of a seat-width axis of the first rear seat 5 (rightward, in the present embodiment).

The front seat 3 includes a (first) seat cushion 3A and a (first) seatback 3B. The first rear seat 5 includes a (second) seat cushion 5A and a (second) seatback 5B. The second rear seat 7 includes a seat cushion 7A and a seatback 7B.

The seat cushions 3A, 5A, and 7A support buttocks of respective occupants. The seatbacks 3B, 5B, and 7B support backs of the respective occupants. The seatback 3B is coupled to the seat cushion 3A in a pivotable manner in the front-rear direction.

The seatback 5B is coupled to the seat cushion 5A in the pivotable manner in the front-rear direction. The seatback 7B is coupled to the seat cushion 7A in the pivotable manner in the front-rear direction.

Hereinafter, the first seat cushion 3A is referred to as a front seat cushion 3A, and the second seat cushion 5A is referred to as a first rear seat cushion 5A. The first seatback 3B is referred to as a front seatback 3B, and the second seatback 5B is referred to as a first rear seatback 5B.

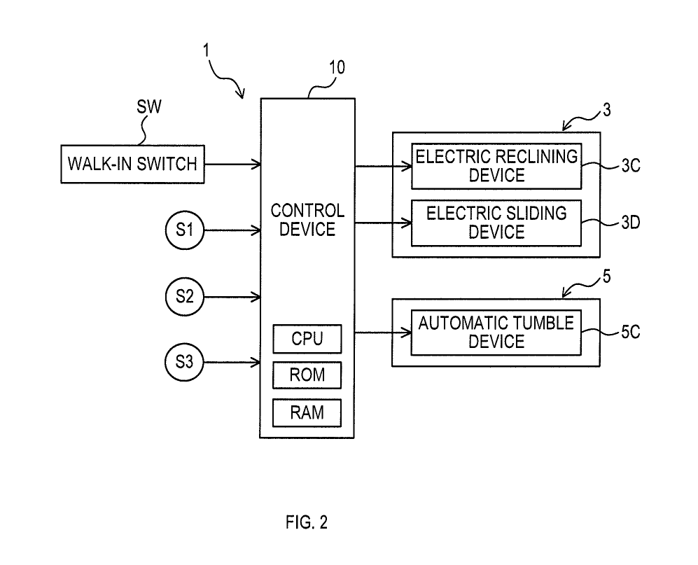

As shown in FIG. 2, the front seat 3 includes at least an electric reclining device 3C and an electric sliding device 3D. The electric reclining device 3C causes the front seatback 3B to pivot by an electric actuator (not shown) such as an electric motor.

With the electric actuator (not shown), the electric sliding device 3D causes the front seat cushion 3A, in other words, the front seat 3 to move in parallel along the front-rear direction. Respective operations of the electric reclining device 3C and the electric sliding device 3D are controlled by a control device 10.

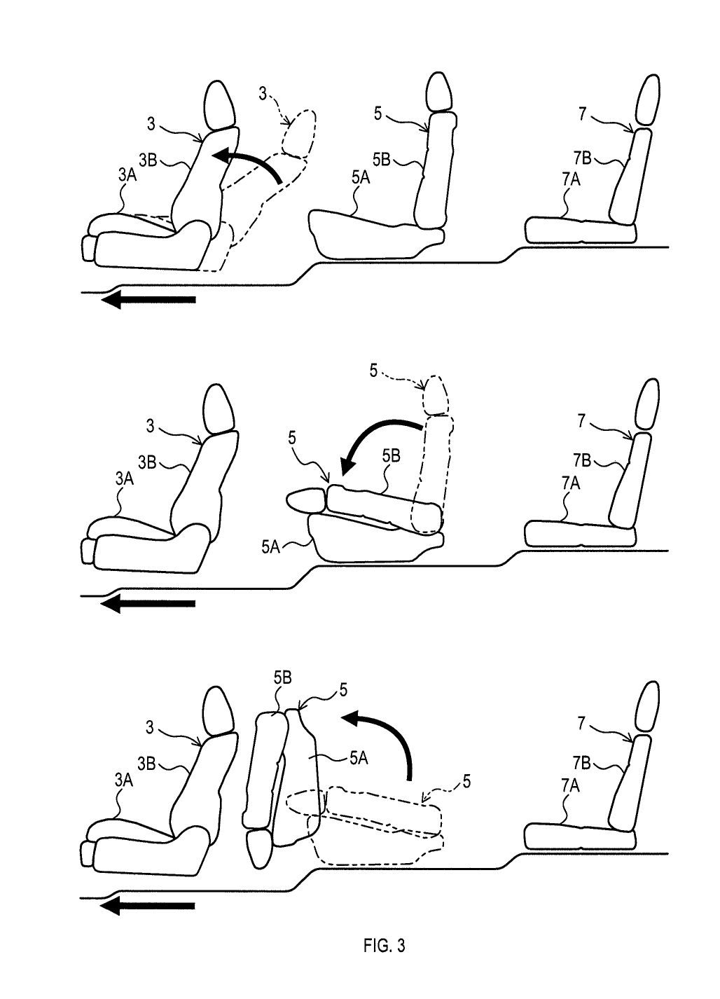

The first rear seat 5 includes at least an automatic tumble device 5C. The automatic tumble device 5C allows the first rear seat 5 to automatically execute a tumble operation (see, FIG. 3). The tumble operation includes a first operation and a second operation.

In the first operation, the second seatback 5B is tilted seat-frontward (frontward). In the second operation, in response to a start of the first operation, the second seat cushion 5A pivots about a seat-front end side as a pivot center such that a seat-rear end of the second seat cushion 5A is displaced frontward. In other word, in the second operation, an entirety of the first rear seat 5 is displaced frontward.

Here, in the present embodiment, the second operation is executed at a time subsequent to an end of the first operation. The end of the first operation refers to a time subsequent to the second seatback 5B being tilted frontward to have a specified angle. An operation of the automatic tumble device 5C is controlled by the control device 10.

The control device 10 is formed with a microcomputer that includes a CPU, a ROM, a RAM, and the like. A software (program) for controlling the electric reclining device 3C, the electric sliding device 3D, and the automatic tumble device 5C is stored in advance in a non-volatile storage of the ROM or the like.

2. Operation Control of Vehicle Seat System

2.1 Overview of Operation Control

The control device 10 is able to execute a boarding or deboarding mode-conversion process. The boarding or deboarding mode is a seat-arranging mode for increasing a distance between the first rear seat 5 and the second rear seat 7. In the boarding or deboarding mode-conversion process, at least front seat-pivot, the first operation, and second operation are executed. The front seat-pivot refers to an operation in which the first seatback 3B is displaced frontward in a pivoting manner.

The control device 10 starts executing the boarding or deboarding mode-conversion process in response to a “walk-in operation” being commanded by the occupant. In the present embodiment, the occupant operates a walk-in switch SW. In response to this, the control device 10 recognizes that the “walk-in operation” is commanded.

During execution of the boarding or deboarding mode-conversion process, the control device 10 executes the second operation in response to the first seatback 3B being placed in a specified state subsequent to execution of the front seat-pivot. During the front seat-pivot, the control device 10 according to the present embodiment also executes a sliding operation in which the front seat cushion 3A is displaced frontward in a sliding manner.

2.2 Details of Operation Control

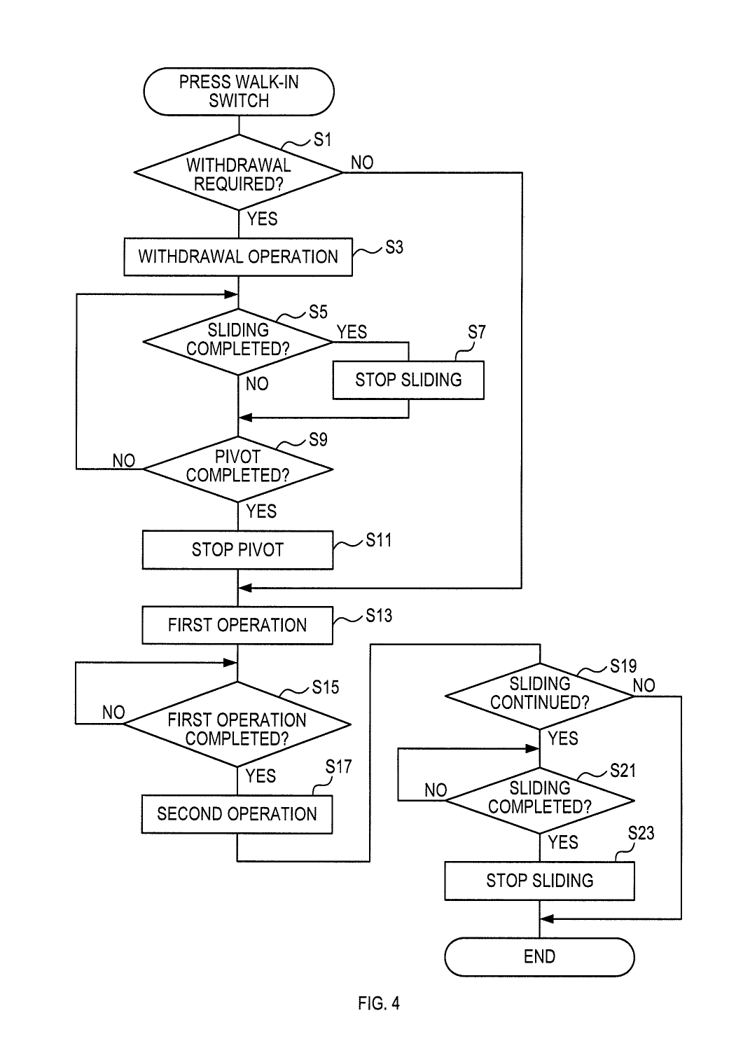

A flow chart shown in FIG. 4 is one example flowchart for executing the aforementioned operation control. In other words, details of a control flow are not limited to a control flow shown in FIG. 4.

In response to an operation of the walk-in switch SW, the control device 10 determines whether it is necessary to execute a withdrawal operation of the front seat 3, in other words, the front seat-pivot and the sliding operation (S1). This determination is made on the basis whether a state and a position of the front seat 3, at a time when the walk-in switch SW is operated, satisfies a specified condition.

In response to a determination that the withdrawal operation is required (S1: YES), the control device 10 executes the withdrawal operation (S3). Specifically, the control device 10 executes the front seat-pivot and the sliding operation (S3).

Then, the control device 10 determines whether the sliding operation is completed (S5). This determination is made on the basis whether the front seat 3 is positioned more frontward than a specified position is. Therefore, the control device 10 is inputted therein a signal S1 that shows a position of the front seat 3 (see, FIG. 2).

In response a determination that the sliding operation is completed (S5: YES), the control device 10 stops the sliding operation (S7) and thereafter determines whether the front seat-pivot is completed (S9). In response to a determination that the sliding operation is incompleted (S5: NO), the control device 10 determines whether the front seat-pivot is completed with the sliding operation being continued (S9).

This determination is made on the basis whether the front seatback 3B pivots frontward to a position with a pivot angle more than or equal to a specified pivot angle. Therefore, the control device 10 is inputted therein a signal S2 that shows a pivot angle of the front seatback 3B (see, FIG. 2).

In response to a determination that the front seat-pivot is completed (S9: YES), the control device 10 stops the front seat-pivot (S11) and thereafter executes the first operation (S13). In response to a determination that the front seat-pivot is incompleted (S9: NO), the control device 10 executes S5.

In response to execution of the first operation, the control device 10 determines whether the first operation is completed (S15). This determination is made on the basis whether the second seatback 5B pivots frontward to a position with a pivot angle more than or equal to a specified pivot angle. Therefore, the control device 10 is inputted therein a signal S3 that shows a pivot angle of the first rear seatback 5B (see, FIG. 2).

In response to a determination that the first operation is completed (S15: YES), the control device 10 executes the second operation (S17). Here, in response to execution of the second operation, the first rear seat cushion 5A pivots to a specified state (see, FIG. 3).

In response to a determination that the first operation is incompleted (S15: NO), the control device 10 executes S15. In response to a start of the second operation, the control device 10 determines whether the sliding operation is continued (S19).

In response to a determination that the sliding operation is continued (S19: YES), it is determined whether the sliding operation is completed (S21). In response to a determination that the sliding operation is completed (S21: YES), the control device 10 stops the sliding operation (S23).

Where the control device 10 stops the sliding operation (S23) or determines that the sliding operation is discontinued (S19: NO), the control device 10 stops this operation control.

3. Characteristics of Vehicle Seat System According to the Present Embodiment

During the boarding or deboarding mode-conversion process, the control device 10 executes the second operation in response to the front seatback 3B being placed in the specified state subsequent to the execution of the front seat-pivot, in other words, completion of the front seat pivot.

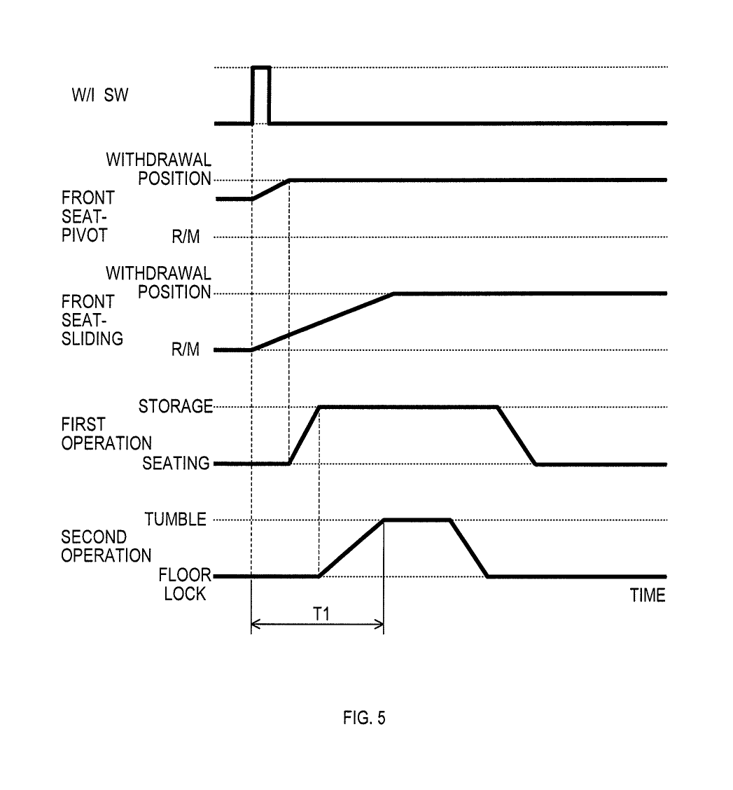

Consequently, this shortens a time duration until the second rear seat 7 becomes available for boarding or deboarding (hereinafter, referred to as a boarding or deboarding-enabling time T1 (see, FIG. 5)), in comparison with a vehicle seat system in which the first rear seat 5 is operated subsequent to response to retreat of the front seat 3 being completed.

Here, in FIG. 5, “W/I SW” indicates the walk-in switch SW; and “R/M” indicates the seat-rearmost position (rearmost position) within a displaceable range. “Tumble” means that the first rear seat cushion 5A is placed in a raised state.

“Floor lock” means that the first rear seat cushion 5A is in a seatable position. “Storage” means that the first rear seatback 5B is tilted frontward. “Seating” means that the first rear seatback 5B is in a seatable position.

Here, at a time when the boarding or deboarding mode-conversion process is started, the front seat 3 may be in the rearmost position within the displaceable range. In this case, in response to the execution of the second operation, a contacting state may occur in which the front seat 3 and the first rear seat 5 come in contact with each other.

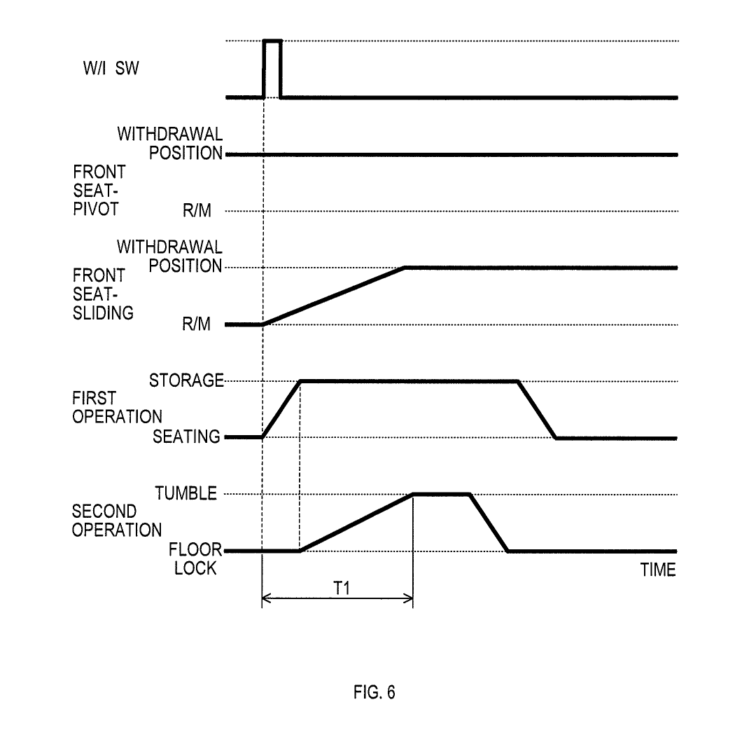

Specifically, in the contacting state, the front seatback 3B and the first rear seatback 5B come in contact with each other (see, FIG. 6). Consequently, this further shortens the boarding or deboarding-enabling time T1.

### Second Embodiment

The first and second operations according to the aforementioned embodiment are to achieve a tumble function. In contrast, a first operation and a second operation according to the present embodiment are to achieve a tip-up function.

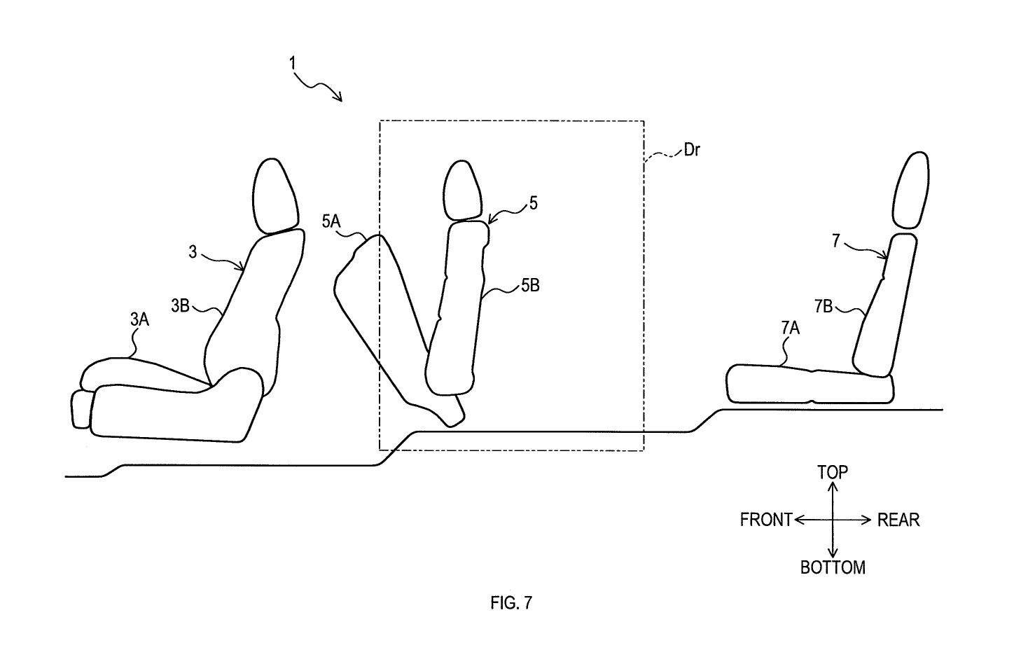

Specifically, in the first operation, the first rear seat cushion 5A pivots about a seat-rear end side as a pivot center such that a seat-front end of the first rear seat cushion 5A is displaced rearward. In the second operation, in response to the start of the first operation, the entirety of the first rear seat 5 is displaced frontward (see, FIG. 7).

Here, in the present embodiment, the front seatback 3B and the first rear seat cushion 5A may come in contact with each other.

The same constituent feature(s) and the like as in the aforementioned embodiment is labelled with the same reference numeral as in the aforementioned embodiment and thus, an overlapped explanation is omitted.

### Other Embodiments

The present disclosure is also applicable to a vehicle neither includes the tumble function nor the tip-up function.

The contacting state in which the front seat 3 and the first rear seat 5 come in contact with each other may not necessarily occur in response to the execution of the second operation.

The sliding operation may not be necessarily executed. Further, the sliding operation may be executed subsequent to the execution of the front seat-pivot.

The vehicle door Dr may be a swing-type (pivot-type) door.

The present disclosure may be applied to seats used in railroad vehicles, ships, boats, and aircrafts, as well as for built-in seats used in theaters and homes.

Moreover, the present disclosure is not limited to the above-described embodiments as long as it falls within the spirit of the invention described in claims. Accordingly, the present disclosure may be formed in combination of at least two of the above-described embodiments.

What is claimed is:

1. A vehicle seat system comprising:
a first seat mounted onto a vehicle, the first seat including a first seat cushion and a first seatback;
a second seat mounted seat-rearward of the first seat within the vehicle and including a second seat cushion and a second seatback;
a third seat mounted seat-rearward of the second seat within the vehicle; and
a control device for controlling respective displacement of the first seat cushion, the first seatback, the second seat cushion, and the second seatback, the control device being able to execute a boarding or deboarding mode-conversion process in which a distance between the second seat and the third seat is increased;
wherein the vehicle seat system executes, during execution of the boarding or deboarding mode-conversion process:
front seat-pivot in which the first seatback is displaced seat-frontward in a pivoting manner;
a first operation in which at least one of the second seat cushion or the second seatback is displaced relative to the other of the second seat cushion or the second seatback so that the second seat cushion faces the second seatback; and
a second operation in which the second seat is displaced seat-frontward; and
wherein the control device executes, during the execution of the boarding or deboarding mode-conversion process, the second operation in response to the first seatback being placed in a specified state subsequent to execution of the front seat-pivot.

2. The vehicle seat system according to claim 1,
wherein, in response to execution of the second operation, a contacting state occurs in which the first seat and the second seat come in contact with each other.

3. The vehicle seat system according to claim 2,
wherein the control device causes the second seatback to be tilted seat-frontward in the first operation, and causes, subsequent to a start of the first operation, the second seat cushion to pivot about a seat-front end side of the second seat cushion as a pivot center in the second operation such that a seat-rear end of the second seat cushion is displaced seat-frontward.

4. The vehicle seat system according to claim 3,
wherein, in the contacting state, the first seatback and the second seatback come in contact with each other.

5. The vehicle seat system according to claim 1,
wherein the control device causes the first seat cushion to be displaced seat-frontward in a sliding manner during the front seat-pivot.
